(19) United States
(12) Patent Application Publication
(10) Pub. No.: US 2003/0116100 A1
(43) Pub. Date: Jun. 26, 2003

(54) Shotgun sound simulator

(76) Inventor: Bernard TedFord Cullen, LaSalle (CA)

Correspondence Address: ADE & COMPANY, 1700-360 MAIN STREET, WINNIPEG, MB, R3C3Z3, CA

(21) Appl. No.: 10/306,739

(22) Filed: Nov. 29, 2002

Related U.S. Application Data
(60) Provisional application No. 60/333,510, filed on Nov. 28, 2001.

(51) Int. Cl. B64D 1/04

(52) U.S. Cl. 119/719; 102/355; 89/1.35; 102/302

(57) ABSTRACT

A shotgun sound simulating device comprises an elongate tube having a hollow interior, an open end at one end of the tube, an ignitable mixture arranged to be injected into the tube, a baffle within the tube and an ignition device arranged to ignite the ignitable mixture. Ignition of the ignitable mixture with the tube creates a sound effect to simulate a sound created by the firing of a shotgun.

This application claims priority from U.S. Provisional Application No. 60/333,510, filed Nov. 28, 2001.

### FIELD OF THE INVENTION

The present invention relates to shotgun sound simulator for use in competitions and/or training hunting dogs.

### BACKGROUND

Conventionally, in training retriever dogs and in competitions with training dogs a shotgun has to be fired to simulate an environment and situation found while hunting ducks, geese and the like. Specifically, during competitions a person, usually a teenager, is hired to be positioned in a field and instructed to shoot a shotgun, armed with blank shells, and to throw or launch a dummy into the air in which a hunting dog would retrieve. New regulations prohibit firing of blank shells without a specific permit for the person firing the shotgun. This can add to the cost of hiring the person as well as limiting the availability of properly permitted person(s) to do the task.

### SUMMARY

The present invention provides a safe alternative to using blanks fired by shotguns during competition and training of retriever dogs and the like.

According to one aspect of the present invention there is provided a shotgun sound simulating device comprises:

an elongate tube having a hollow interior;

an open end at one end of the tube;

an ignitable mixture arranged to be injected into the tube;

an ignition device arranged to ignite the ignitable mixture;

a baffle within the tube;

wherein ignition of the ignitable mixture with the tube creates a sound effect to simulate a sound created by the firing of a shotgun.

Preferably the baffle is spaced from a closed end of the tube;

Conveniently the baffle is arranged to have an adjustable mount such that distance between a closed end on the tube and the baffle can be adjusted.

Preferably the ignitable mixture is injected between the baffle and a closed end of the tube.

Conveniently the ignitable mixture is propane.

Preferably the baffle is arranged to restrict a space between a closed end of the tube and has at least one hole arranged to release the pressure caused by the ignited mixture.

Conveniently a sleeve which arranged to shield the interior of the tube from outside elements.

Conveniently the sleeve encapsulates the open end which provides a shielded opening and is arranged to allow the sound to e released from the tube.

### BRIEF DESCRIPTION OF THE DRAWINGS

In the accompanying drawings, which illustrate an exemplary embodiment of the present invention:

FIG. 1 is a side elevational view of the present invention.

FIG. 2 is a vertical cross section of FIG. 1.

FIG. 3 is a vertical cross section along the lines 3-3 of FIG. 2.

### DETAILED DESCRIPTION

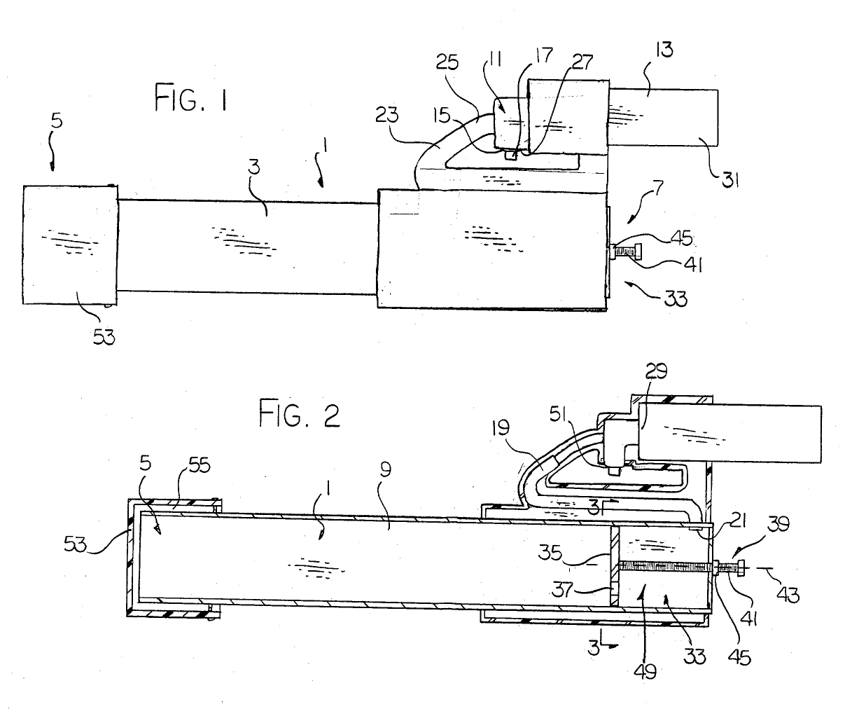

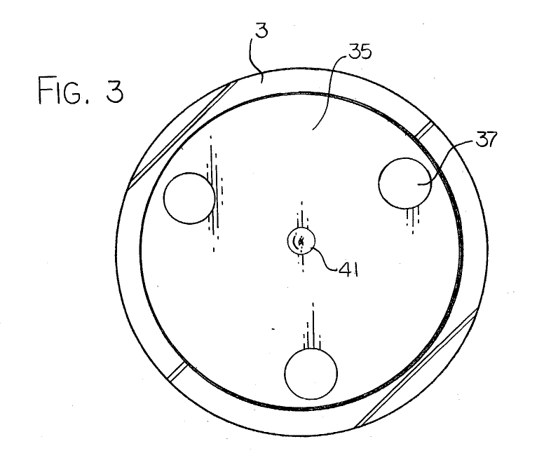

As illustrated in FIGS. 1 and 2, a shotgun sound simulating device 1 is designed to provide a safe alternative to an actual shotgun. The device has an elongate tube 3 having an open end 5, a closed end 7 and a hollow interior 9. Connected to the tube is an injection arrangement 11 which uses propane gas within a cylinder 13 to inject the gas into the tube. The injection arrangement has a release valve 15 attached to the cylinder which controls the flow of gas from the cylinder. A control switch 17 on the release valve is accessible by a user to control the flow. A hose 19 extends from the release valve and the cylinder and is connected to the tube adjacent the closed end. The hose extends within the tube and has an open end 21 therein. The release valve controls the flow of gas from the cylinder, through the hose and into the tube.

A shell 23 is moulded to support the cylinder, release valve, hose and the closed end of the tube. The shell has a handle 25 which provides a user with a suitable carrying and firing support and has an open portion 27 for providing access to the release valve. The shell encloses a threaded end 29 of the cylinder whereby the cylinder attaches to the release valve. An engaging end 31 of the cylinder extends out of the shell such that the user can remove and replace the cylinder by unscrewing or screwing the cylinder from the release valve.

A baffle arrangement 33 is coupled to the tube at the closed end. The baffle arrangement has a disk-shaped baffle 35, as shown in FIG. 3, is arranged to fit within the tube. The baffle has a diameter sized such that an edge of the baffle seals the tube. The baffle has a plurality of holes 37. The baffle has an adjustable position within the tube. A baffle adjustment 39 has a threaded shaft 41 which extends along an axis 43 of the tube from the closed end. The threaded shaft is coupled to the baffle and has a lock nut 45 at the closed end outside the hollow interior. The threaded shaft is arranged such that rotation of the threaded shaft moves the baffle inwards and outwards relative to the closed end. The hose extends into the tube between the baffle and the closed end. The baffle is arranged to sufficiently trap the injected propane within a space 49 between the baffle and the closed end such that the gas can be ignited. The holes on the baffle are arranged to allow the gas to escape the space and exit the open end of the tube. Positioning of the baffle within the tube provides different tones emitted by the device.

An ignition device 51 is coupled to the hose adjacent the release valve on the hose which is arranged to ignite the gas injected into the tube. Ignition of the gas creates a sounds arranged to simulate a shot gun.

The open end has a cap 53 which is arranged to enclose the open end. The cap is fitted around the open end of the tube and is sized to provide a space 55 which enables the ignited gas to escape. The cap is arranged to shelter the interior of the tube from the elements. The cap blocks wind and/or water from entering the tube which would hinder the performance of the device.

In use, a user holds the device in a general direction, the user then opens the release valve such that the propane is allowed to flow into the space within the tube. After a sufficient amount of propane has entered the tube, the user closes the release valve and ignites the gas. The ignition of the gas causes a sound which simulates the sound of a shot gun fire. In order to create the desired sound the user can adjust the volume of the space by rotating the threaded shaft to either position the baffle closer to or away from the closed end.

During competition use, a user launches a dummy game bird into the air, and ignites the device such that it simulates a shooting of the game bird in which the competing dog is trained to retrieve the dummy bird.

While one embodiment of the present invention has been described in the foregoing, it is to be understood that other embodiments are possible within the scope of the invention. The invention is to be considered limited solely by the scope of the appended claims.

1. A shotgun sound simulating device comprises:
an elongate tube having a hollow interior;
an open end at one end of the tube;
an ignitable mixture arranged to be injected into the tube;
an ignition device arranged to ignite the ignitable mixture;
a baffle within the tube;
wherein ignition of the ignitable mixture with the tube creates a sound effect to simulate a sound created by the firing of a shotgun.

2. The device according to claim 1 wherein the baffle is spaced from a closed end of the tube;

3. The device according to claim 1 wherein the baffle is arranged to have an adjustable mount such that distance between a closed end on the tube and the baffle can be adjusted.

4. The device according to claim 1 wherein the ignitable mixture is injected between the baffle and a closed end of the tube.

5. The device according to claim 1 wherein the ignitable mixture is propane.

6. The device according to claim 1 wherein the baffle is arranged to restrict a space between a closed end of the tube and has atleast one hole arranged to release the pressure caused by the ignited mixture.

7. The device according to claim 1 wherein a sleeve which arranged to shield the interior of the tube from outside elements.

8. The device according to claim 7 wherein the sleeve encapsulates the open end which provides a shielded opening and is arranged to allow the sound to e released from the tube.
